(19) United States
(12) Patent Application Publication
(10) Pub. No.: US 2025/0374403 A1
(43) Pub. Date: Dec. 4, 2025

(54) UWB-BASED VEHICLE LIGHTING CONTROL SYSTEM AND METHOD

(71) Applicants: HYUNDAI MOTOR COMPANY, Seoul (KR); KIA CORPORATION, Seoul (KR)

(72) Inventors: Xu Qiang Sun, Yantai (CN); Zi Shuan Song, Yantai (CN)

(73) Assignees: HYUNDAI MOTOR COMPANY, Seoul (KR); KIA CORPORATION, Seoul (KR)

(21) Appl. No.: 19/052,004

(22) Filed: Feb. 12, 2025

(30) Foreign Application Priority Data
May 31, 2024 (CN) 202410702808.8

(51) Int. Cl. H05B 47/115; B60Q 1/00; H05B 47/165; H05B 47/17; H05B 47/19

(52) U.S. Cl. CPC H05B 47/115; B60Q 1/0041; H05B 47/165; H05B 47/17; H05B 47/19; B60Q 2400/40; B60Q 2900/30

(57) ABSTRACT

An ultra wide band (UWB)-based vehicle lighting control system includes a UWB communication equipment and a vehicle-mounted UWB communication device including a UWB processing module and a plurality of vehicle-mounted UWB communication modules. The plurality of vehicle-mounted UWB communication modules is configured to transmit a UWB communication signal received from a user to the UWB processing module. The system further includes a main control device configured to determine whether conditions of a welcome or escort operation mode of vehicle lighting are satisfied and generate a vehicle lighting control signal when the conditions of the welcome or escort operation mode of the vehicle lighting are satisfied. The system further includes a vehicle lighting control device configured to operate the vehicle lighting based on the vehicle lighting control signal of the main control device and change a position to which the vehicle lighting emits light based on a user movement.

### CROSS-REFERENCE TO RELATED APPLICATION

This application claims the priority to and the benefit of Chinese Patent Application No. 202410702808.8 filed in the Chinese National Intellectual Property Administration on May 31, 2024, the entire contents of which are incorporated herein by reference.

### TECHNICAL FIELD

The present disclosure relates to a field of vehicle control technology and more particularly relates to an ultra wide band (UWB)-based vehicle lighting control system and a UWB-based vehicle lighting control method.

### BACKGROUND

As vehicle intelligence advances, the welcome mode and escort mode of the vehicle may become more intelligent and human-friendly and may provide a user with a more comfortable and safe driving experience.

Currently, when a driver unlocks a vehicle using a vehicle key or a smart device, a vehicle headlight may be automatically turned on to provide lighting to the driver. However, a light emission direction of the headlight may be generally fixed, and thus the headlight fails to directly light a road on which the driver is walking. If the driver stands while facing the front side of the vehicle and unlocks the vehicle, the headlight may directly light the driver eyes and thus may cause temporary discomfort. When the driver gets out of the vehicle and locks the vehicle, the headlight direction may not be adjusted based on a driver movement although the headlight is turned on for a certain period of time to provide lighting to the driver. If the vehicle is parked on a sloped road, the headlight may not light the road evenly because the light emission direction of the headlight is inclined with a vehicle body.

Therefore, there is a need to improve a vehicle lighting control method to provide the user with the more comfortable and safe driving experience, in addition to providing a basic lighting function.

The description of the background technology described above is provided only for a deeper understanding of a technical approach disclosed in the present disclosure (e.g., technical means in use, a technical problem to be solved, or a derived technical effect). The above description should not be considered as prior art already known to those having ordinary skill in the art or as suggesting any form of technology.

### SUMMARY

The present disclosure aims to provide a system and a method for providing a user with vehicle lighting that is more intelligently controlled by detecting a user position relative to a vehicle based on ultra-wideband (UWB) communication technology.

According to an embodiment, an ultra wide band (UWB)-based vehicle lighting control system includes a UWB communication equipment configured to transmit and receive a UWB communication signal. The system further includes a vehicle-mounted UWB communication device including a UWB processing module. The UWB processing module is configured to detect user position information based on the UWB communication signal received from the UWB communication equipment of the user. The UWB processing module is further configured to convert the detected user position information into a vehicle-mounted communication signal. The vehicle-mounted UWB communication device further includes a plurality of vehicle-mounted UWB communication modules communicatively connected to the UWB processing module. The plurality of vehicle-mounted UWB communication modules is configured to perform UWB communication with the UWB communication equipment carried by the user. The plurality of vehicle-mounted UWB communication modules is further configured to transmit the UWB communication signal received from the UWB communication equipment of the user to the UWB processing module. The system further includes a main control device communicatively connected to the vehicle-mounted UWB communication device. The main control device is configured to determine whether conditions of a welcome operation mode or an escort operation mode of vehicle lighting are satisfied. The main control device is further configured to generate a vehicle lighting control signal based on the vehicle-mounted communication signal of the vehicle-mounted UWB communication device when the conditions of the welcome operation mode or an escort operation mode of the vehicle lighting are satisfied. The system further includes a vehicle lighting control device communicatively connected to the main control device and electrically connected to the vehicle lighting. The vehicle lighting control device is configured to operate the vehicle lighting based on the vehicle lighting control signal of the main control device. The vehicle lighting control device is further configured to change a position to which the vehicle lighting emits light based on a user movement.

The conditions of the welcome operation mode or the escort operation mode of the vehicle lighting may include whether a vehicle ignition is turned off, whether all doors are closed and locked, and whether the welcome operation mode or the escort operation mode of the vehicle lighting are turned on. The main control device may be further configured to determine that the conditions of the welcome operation mode or the escort operation mode of the vehicle lighting are satisfied when the vehicle ignition is turned off, all the doors are closed and locked, and the welcome operation mode or the escort operation mode of the vehicle lighting are turned on. The main control device may be further configured to determine that the conditions of the welcome operation mode or the escort operation mode of the vehicle lighting are not satisfied when the vehicle ignition is not turned off, at least one door is not closed or locked, or the welcome operation mode or the escort operation mode of the vehicle lighting is not turned on.

The welcome operation mode or the escort operation mode of the vehicle lighting may be turned on when buttons related to the welcome operation mode or the escort operation mode of the vehicle lighting are pressed.

The main control device may be further configured to detect whether a user position is within a set range of a vehicle based on the vehicle-mounted communication signal of the vehicle-mounted UWB communication device when the conditions of the welcome operation mode or the escort operation mode of the vehicle lighting are satisfied. The main control device may be further configured to generate the vehicle lighting control signal including a signal causing an emission height of the vehicle lighting to be a first height below the UWB communication equipment carried by the user when the user position is detected to be within the set range of the vehicle.

The set range of the vehicle may indicate a range of distances between the user and a front side, a rear side, a left side, and a right side of the vehicle. The set range of the vehicle may include a first region, a second region, a third region, a fourth region, and a fifth region. The first region is set as a region where the distance between the user and the front side, the rear side, the left side, and the right side of the vehicle is less than or equal to a first distance. The second region is set as a region where the distance between the user and the right side of the vehicle is greater than the first distance and less than or equal to a second distance. The third region is set as a region where the distance between the user and the left side of the vehicle is greater than the first distance and less than or equal to the second distance. The fourth region is set as a region where the distance between the user and the front side of the vehicle is greater than the first distance and less than or equal to the second distance. The fifth region is set as a region where the distance between the user and the rear side of the vehicle is greater than the first distance and less than or equal to the second distance.

The vehicle lighting control device may include a headlight controller, a side light controller, and a tail light controller. The headlight controller, the side light controller, and the tail light controller may cause a headlight, a side light, and a tail light to respectively emit light to the first region when the user position information indicates that the user is in the first region. The headlight controller, the side light controller, and the tail light controller may cause the headlight, the side light, and the tail light respectively to emit light toward the right side of the vehicle when the user position information indicates that the user is in the second region. The headlight controller, the side light controller, and the tail light controller may cause the headlight, the side light, and the tail light to respectively emit light toward the left side of the vehicle when the user position information indicates that the user is in the third region. The headlight controller, the side light controller and the tail light controller may cause the headlight, the side light, and the tail light to respectively emit light toward the front side of the vehicle when the user position information indicates that the user is in the fourth region. The headlight controller, the side light controller, and the tail light controller may cause the headlight, the side light and the tail light to respectively emit light toward the rear side of the vehicle when the user position information indicates that the user is in the fifth region.

The system may further include a display device, wherein the display device may be communicatively connected to the main control device. The user may set the vehicle lighting to emit light to the first height below the UWB communication equipment carried by the user using the display device. The first height is set to a range of 20 cm to 160 cm.

The UWB communication equipment may include a vehicle key and/or a mobile device. The plurality of vehicle-mounted UWB communication modules may include five vehicle-mounted UWB communication modules being respectively installed at a left front corner, right front corner, a left rear corner, a right rear corner, and a front roof of the vehicle.

The UWB communication equipment of the user may include a vehicle lock button. The vehicle lighting may be turned off when the user presses the vehicle lock button while the vehicle lighting is in operation.

A communicative connection may include a connection using a wired communication method. The wired communication method may include a controller area network (CAN), a universal serial bus (USB), a high definition multimedia interface (HDMI), or a digital visual interface (DVI).

According to an embodiment, an ultra wide band (UWB)-based vehicle lighting control method includes transmitting and receiving, by a UWB communication equipment carried by a user, a UWB communication signal. The method further includes detecting, by a vehicle-mounted UWB communication device, user position information based on the UWB communication signal received from the UWB communication equipment of the user. The method further includes operating, by a vehicle lighting control device, vehicle lighting based on a vehicle lighting control signal received from a main control device. The method further includes changing, by the vehicle lighting control device, a position to which the vehicle lighting emits light based on a user movement.

The method may further include determining, by a main control device, whether conditions of a welcome operation mode or an escort operation mode of vehicle lighting are satisfied. The method may further include generating, by the main control device, a vehicle lighting control signal based on a vehicle-mounted communication signal received from the vehicle-mounted UWB communication device when the conditions of the welcome operation mode or the escort operation mode of the vehicle lighting are satisfied,

The conditions of the welcome operation mode or the escort operation mode of the vehicle lighting may include whether a vehicle ignition is turned off, whether all doors are closed and locked, and whether the welcome operation mode or the escort operation mode of the vehicle lighting are turned on. The method may further include determining, by the main control device, that the conditions of the welcome operation mode or the escort operation mode of the vehicle lighting are satisfied when the vehicle ignition is turned off, all the doors are closed and locked, and the welcome operation mode or the escort operation mode of the vehicle lighting are turned on. The method may further include determining, by the main control device, that the conditions of the welcome operation mode or the escort operation mode of the vehicle lighting are not satisfied when the vehicle ignition is not turned off, at least one door is not closed or locked, or the welcome operation mode or the escort operation mode of the vehicle lighting is not turned on.

The method may further include turning on the welcome operation mode or the escort operation mode of the vehicle lighting when buttons related to the welcome operation mode or the escort operation mode of the vehicle lighting are pressed.

The method may further include detecting, by the main control device, whether a user position is within a set range of a vehicle based on the vehicle-mounted communication signal of the vehicle-mounted UWB communication device when the conditions of the welcome operation mode or the escort operation mode of the vehicle lighting are satisfied. The method may further include generating, by the main control device, the vehicle lighting control signal including a signal causing an emission height of the vehicle lighting to be a first height below the UWB communication equipment carried by the user when the user position is detected to be within the set range of the vehicle.

The set range of the vehicle may indicate a range of distances between the user and the front side, the rear side, the left side, and the right side of the vehicle. The set range of the vehicle may include a first region, a second region, a third region, a fourth region, and a fifth region. The first region is set as a region where the distance between the user and the front side, the rear side, the left side, and the right side of the vehicle is less than or equal to a first distance. The second region is set as a region where the distance between the user and the right side of the vehicle is greater than the first distance and less than or equal to a second distance. The third region is set as a region where the distance between the user and the left side of the vehicle is greater than the first distance and less than or equal to the second distance. The fourth region is set as a region where the distance between the user and the front side of the vehicle is greater than the first distance and less than or equal to the second distance. The fifth region is set as a region where the distance between the user and the rear side of the vehicle is greater than the first distance and less than or equal to the second distance.

The method may further include generating, by the main control device, the vehicle lighting control signal causing a headlight, a side light, and a tail light to respectively emit light to the first region when the user position information indicates that the user is in the first region. The method may further include generating, by the main control device, the vehicle lighting control signal causing the headlight, the side light, and the tail light respectively to emit light toward the right side of the vehicle when the user position information indicates that the user is in the second region. The method may further include generating, by the main control device, the vehicle lighting control signal causing the headlight, the side light, and the tail light to respectively emit light toward the left side of the vehicle when the user position information indicates that the user is in the third region. The method may further include generating, by the main control device, the vehicle lighting control signal causing the headlight, the side light and the tail light to respectively emit light toward the front side of the vehicle when the user position information indicates that the user is in the fourth region. The method may further include generating, by the main control device, the vehicle lighting control signal causing the headlight, the side light and the tail light to respectively emit light toward the rear side of the vehicle when the user position information indicates that the user is in the fifth region.

The method may further include setting, by the user, the vehicle lighting to emit light to the first height below the UWB communication equipment carried by the user using the display device. The method may further include setting the first height to a range of 20 cm to 160 cm.

The method may further include turning off the vehicle lighting when the user presses a vehicle lock button while the vehicle lighting is in operation.

The UWB communication equipment may include a vehicle key and/or a mobile device. The vehicle-mounted UWB communication device may include a plurality of vehicle-mounted UWB communication modules. The plurality of vehicle-mounted UWB communication modules may include five vehicle-mounted UWB communication modules being respectively installed at a left front corner, a right front corner, a left rear corner, a right rear corner, and a front roof of the vehicle.

The present disclosure uses the technology approach described above to thus achieve the following effects:
1. The accurate user position relative to the vehicle may be determined because the distance and position are measured with high precision by using the ultra wide band (UWB) communication technology.
2. The direction of the vehicle lighting may be adjusted by coupling the user position information thereto in the welcome mode and escort mode of the vehicle lighting. For example, if it is detected that the user approaches the left side of the vehicle, the vehicle lighting on the left side may automatically point down and be inclined toward the user to prevent from directly emitting light into the driver eyes.
3. If the user movement is detected, the vehicle lighting may be adjusted based on the real-time user position to ensure the provision of the optimal road lighting while not obstructing the driver view.
4. If it is detected that the user leaves the vehicle but is still active in the surroundings, such as carrying the items or inspecting the vehicle, the vehicle lighting may be maintained to be turned on to thus provide the user with the necessary lighting, which may increase the safety of nighttime parking and pedestrians, while also providing the convenience to the user.

### BRIEF DESCRIPTION OF DRAWINGS

Hereinafter, embodiments of the present disclosure are described in more detail with reference to the accompanying drawings. For clarity, the same or equivalent components in the different drawings are denoted by the same drawing numbers. The accompanying drawings are provided as examples to describe the present disclosure, and the present disclosure is not limited to proportions shown in the drawings.

FIG. 1 is a block diagram showing an ultra wide band (UWB)-based vehicle lighting control system according to an embodiment of the present disclosure.

FIG. 2 is a schematic diagram showing an example of a set range of a vehicle according to an embodiment of the present disclosure.

FIG. 3 is a flowchart showing an ultra wide band (UWB)-based vehicle lighting control method according to an embodiment of the present disclosure.

### DETAILED DESCRIPTION

Hereinafter, embodiments of the present disclosure are described in detail. These embodiments are implemented based on a technical approach of the present disclosure, and specific implementation methods and specific manipulation processes are disclosed. However, the scope of the present disclosure is not limited to the embodiments described below. When a controller, module, component, device, element, part, unit, or the like of the present disclosure is described as having a purpose or performing an operation, function, or the like, the controller, module, component, device, element, part, unit, or the like should be considered herein as being “configured to” meet that purpose or to perform that operation or function. Each controller, module, component, device, element, part, unit, and the like may separately embody or be included with a processor and a memory, such as a non-transitory computer readable media, as part of the apparatus.

Hereinafter, the embodiments of the present disclosure are described in detail with reference to the accompanying drawings.

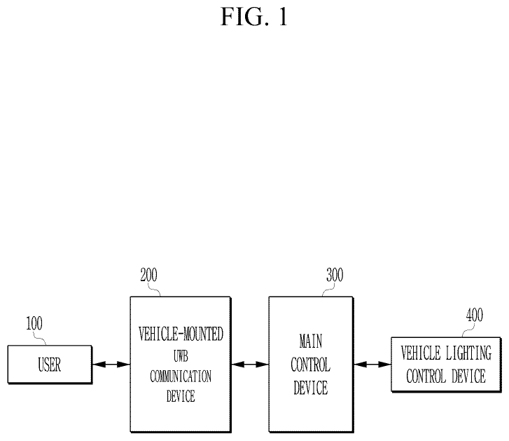

FIG. 1 is a block diagram showing an ultra wide band (UWB)-based vehicle lighting control system according to an embodiment of the present disclosure. A UWB-based vehicle lighting control system according to an embodiment of the present disclosure may include a user 100, a vehicle-mounted UWB communication device 200, a main control device 300, and a vehicle lighting control device 400.

The user 100 may carry UWB communication equipment for transmitting and receiving a UWB communication signal. The UWB communication equipment may include a vehicle key, a mobile device, and/or the like. The mobile device may include all handheld mobile devices such as a mobile phone and a tablet.

Ultra-wideband (UWB) technology indicates wireless communication technology for transmitting data by using a narrow pulse at a nanosecond level. The UWB technology may achieve centimeter-level, even millimeter-level, positioning accuracy. Thus, the UWB technology is very useful for capturing a subtle movement trajectory and a height change. A UWB signal has a very narrow time width, which allows a receiver to acquire a very high time resolution during measurement, and thus the positioning accuracy is ensured. The UWB technology may not only support two-dimensional (2D) plane positioning but also perform three-dimensional (3D) space positioning. This feature indicates that the UWB technology is capable of detecting a user movement in a three-dimensional space, including a vertical movement, and perfectly recording a user movement trajectory and a height of the UWB communication equipment carried by the user. UWB positioning technology having high precision, a multi-dimensional space positioning function, and a feature of being applicable to a complex environment is an ideal selection for detecting the user movement trajectory and the height of the UWB communication equipment carried by the user.

The vehicle-mounted UWB communication device 200 may include a UWB processing module and a plurality of vehicle-mounted UWB communication modules. The UWB processing module may be communicatively connected to each of the plurality of vehicle-mounted UWB communication modules by using a wired communication method. The plurality of vehicle-mounted UWB communication modules may perform UWB communication with the UWB communication equipment carried by the user 100. The plurality of vehicle-mounted UWB communication modules may transmit the received UWB communication signal of the user 100 to the UWB processing module. The UWB processing module may detect position information of the user 100 based on the received UWB communication signal of the user 100 and may convert the detected position information of the user 100 into a vehicle-mounted communication signal.

According to an embodiment of the present disclosure, the wired communication method may include a controller area network (CAN), a universal serial bus (USB), a high definition multimedia interface (HDMI), a digital visual interface (DVI), or the like. Here, the CAN communication method may include powertrain CAN (P_CAN), a vehicle body control device CAN (B_CAN), a chassis control CAN (C_CAN), or the like. However, an embodiment of the present disclosure is not limited to the communication methods described above.

The plurality of vehicle-mounted UWB communication modules may include three, four, five, six or more vehicle-mounted UWB communication modules. According to an embodiment of the present disclosure, the plurality of vehicle-mounted UWB communication modules may include five modules. The five vehicle-mounted UWB communication modules may include: a slave vehicle-mounted UWB communication module installed at a left front corner of a vehicle, a slave vehicle-mounted UWB communication module installed at a right front corner of the vehicle, a slave vehicle-mounted UWB communication module installed at a left rear corner of the vehicle, a slave vehicle-mounted UWB communication module installed at a right rear corner of the vehicle, and a master vehicle-mounted UWB communication module installed near a front roof of the vehicle. However, the plurality of vehicle-mounted UWB communication modules method is not limited to this an arrangement method and may be arranged based on a vehicle structure and actual needs.

The plurality of vehicle-mounted UWB communication modules may be communicatively connected to each other by using the wired communication method. At least one of the plurality of vehicle-mounted UWB communication modules may be communicatively connected to the main control device 300. According to an embodiment of the present disclosure, among the plurality of vehicle-mounted UWB communication modules, only the master vehicle-mounted UWB communication module may be directly communicatively connected to the main control device 300, and the other slave vehicle-mounted UWB communication modules may be communicatively connected to the master vehicle-mounted UWB communication module.

In addition, at least one of the plurality of vehicle-mounted UWB communication modules may also perform communication authentication with the UWB communication equipment of the user 100. According to an embodiment of the present disclosure, only the master vehicle-mounted UWB communication module may perform the communication authentication with the UWB communication equipment of the user 100, and the other slave vehicle-mounted UWB communication modules may detect position information of the UWB communication equipment of the user 100.

The main control device 300 may be communicatively connected to the vehicle-mounted UWB communication device 200 by the wired communication method. The main control device 300 may determine whether conditions of a welcome operation mode or an escort operation mode of vehicle lighting are satisfied. The main control device 300 may generate a vehicle lighting control signal based on the vehicle-mounted communication signal of the vehicle-mounted UWB communication device if the conditions of the welcome or escort operation mode of the vehicle lighting are satisfied. According to an embodiment of the present disclosure, the main control device 300 may be a body domain controller (BDC).

In detail, according to an embodiment of the present disclosure, the conditions of the welcome operation mode or the escort operation mode of the vehicle lighting may include whether a vehicle ignition is turned off, whether all doors are closed and locked, and whether the welcome or escort operation mode of the vehicle lighting are turned on. The main control device 300 may further determine that the conditions of the welcome or escort operation mode of the vehicle lighting are satisfied if the vehicle ignition is turned off, all the doors are closed and locked, and the welcome or escort operation mode of the vehicle lighting are turned on. The main control device 300 may determine that the conditions of the welcome or escort operation mode of the vehicle lighting are not satisfied if at least one of the following occurs: the vehicle ignition is not turned off, at least one door is not closed or locked, or the welcome or escort operation mode of the vehicle lighting is not turned on.

Buttons related to the welcome or escort operation mode of the vehicle lighting may be installed on the center console and/or vehicle-mounted display device of the vehicle. The vehicle-mounted display device may be communicatively connected to the main control device 300 or may be installed as an instrument panel or as a flat display device such as a liquid crystal display (LCD), an organic light emitting diode (OLED), or a plasma display panel (PDP). The welcome or escort operation mode of the vehicle lighting may be turned on if the buttons related to the welcome or escort operation mode of the vehicle lighting are pressed.

The main control device 300 may detect whether the user position is within a set range of the vehicle based on the vehicle-mounted communication signal of the vehicle-mounted UWB communication device if the conditions of the welcome or escort operation mode of the vehicle lighting are satisfied. The main control device 300 may generate the vehicle lighting control signal if the user position is detected to be within the set range of the vehicle.

According to an embodiment of the present disclosure, the set range of the vehicle may be a range of distances between the user and the front, rear, left, and right sides of the vehicle. The front, rear, left, and right sides of the vehicle may be generally defined based on a direction of a vehicle head. In other words, the direction pointed by the vehicle head is the front side of the vehicle, which is also a direction a driver faces when sitting in a driver seat, and a direction opposite to the vehicle head is the rear side of the vehicle. From a driver perspective, the driver's left hand direction is the left side of the vehicle, and the driver's right hand direction is the right side of the vehicle.

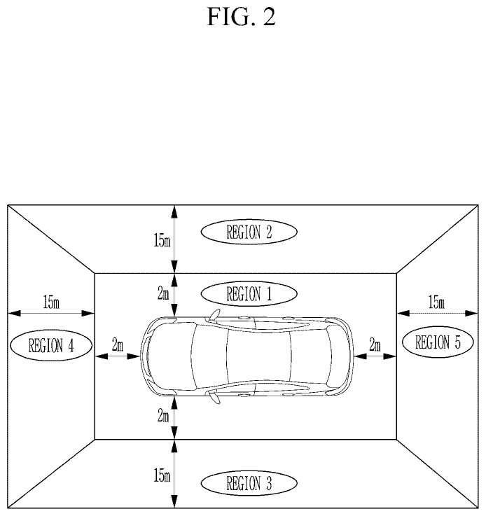

FIG. 2 is a schematic diagram showing an example of the set range of the vehicle according to an embodiment of the present disclosure. Referring to FIG. 2, the set range of the vehicle may include a first region, a second region, a third region, a fourth region, and a fifth region.

The first region may be set as a region where the distance between the user and the front, rear, left, and right sides of the vehicle is equal to or less than a first distance. The second region may be set as a region where the distance between the user and the right side of the vehicle is greater than the first distance and less than or equal to a second distance. The third region may be set as a region where the distance between the user and the left side of the vehicle is greater than the first distance and less than or equal to the second distance. The fourth region may be set as a region where the distance between the user and the front side of the vehicle is greater than the first distance and less than or equal to the second distance. The fifth region may be set as a region where the distance between the user and the rear side of the vehicle is greater than the first distance and less than or equal to the second distance.

As shown in FIG. 2, the first distance may be set to a range of 1 m to 3 m, and the first distance according to an embodiment of the present disclosure may be set to 2 m. The second distance may be set to a range of 12 m to 18 m, and the second distance according to an embodiment of the present disclosure may be set to 15 m. The set range of the vehicle and a division of regions within the set range is only an example, and the present disclosure is not limited thereto.

According to an embodiment of the present disclosure, the vehicle lighting control signal may include a signal for turning on the corresponding vehicle lighting. The vehicle lighting control signal may further include a signal causing an emission height of the corresponding vehicle lighting to be a first height below the UWB communication equipment carried by the user.

For the emission height of vehicle lighting, the user may set the vehicle lighting to emit light to the first height below the UWB communication equipment carried by the user using the vehicle-mounted display device. The vehicle-mounted display device may generally include an interface for adjusting the emission height of the vehicle lighting and thus may allow the driver to adjust the emission height of the vehicle lighting as needed. Such a personalized setting may be stored in a vehicle system and associated with specific UWB communication equipment. Whenever the system uses this method to detect the specific UWB communication equipment, the vehicle lighting may be automatically adjusted to a predetermined height and thus may light a user foot position, so as to implement personalized customization.

UWB communication technology may detect a 3D position of the UWB communication equipment carried by the user, i.e., the height and accurate position of the UWB communication equipment carried by the user. The UWB communication equipment carried by the user may be generally kept in the user's handbag or trouser pocket, and the first height may thus be set based on a user height. For example, the first height may be set to a range of 20 cm to 160 cm, and the present disclosure is not limited to the above figures. If the height of the UWB communication equipment carried by the user (ground level) is detected as 120 cm and the first height is set to 100 cm, the emission height of the vehicle lighting may be 100 cm below the UWB communication equipment carried by the user, i.e., the user foot position.

The vehicle lighting control device 400 may be communicatively connected to the main control device 300 and electrically connected to the vehicle lighting. The vehicle lighting control device 400 may operate the vehicle lighting based on the vehicle lighting control signal of the main control device 300 and may change a position to which the vehicle lighting emits light based on the user movement.

According to an embodiment of the present disclosure, the vehicle lighting control device may include a vehicle lighting controller such as a headlight controller, a side light controller, or a tail light controller. Control logic for the light emission direction of the vehicle lighting may be configured based on the user position information as follows.

The headlight controller, the side light controller, and the tail light controller may cause headlight, side light, and tail light to respectively emit light to the entire first region evenly if the user position information indicates that the user is in the first region. This configuration indicates that the vehicle lighting emits light based on a standard setting and is not inclined to either side.

The headlight controller, the side light controller, and the tail light controller may cause the headlight, the side light, and the tail light to respectively emit light toward the right side of the vehicle if the user position information indicates that the user is in the second region. This configuration indicates a need to enhance the lighting on a right side road of the vehicle.

The headlight controller, the side light controller, and the tail light controller may cause the headlight, the side light, and the tail light to respectively emit light toward the left side of the vehicle if the user position information indicates that the user is in the third region. This configuration indicates a need to enhance the lighting on a left side road of the vehicle.

The headlight controller, the side light controller, and the tail light controller may cause the headlight, the side light, and the tail light to respectively emit light toward the front side of the vehicle if the user position information indicates that the user is in the fourth region. This configuration indicates a need to enhance the lighting on a front side road of the vehicle.

The headlight controller, the side light controller, and the tail light controller may cause the headlight, the side light, and the tail light to respectively emit light toward the rear side of the vehicle if the user position information indicates that the user is in the fifth region. This configuration indicates a need to enhance the lighting on a rear side road of the vehicle.

The vehicle lighting controller may adjust the direction of the vehicle lighting based on the region including the user position to satisfy a lighting requirement of each region and thus may implement a function of automatically adjusting the lighting direction based on the position information.

The user may set which vehicle lighting to turn on, an emission angle of each vehicle lighting, an emission color, or the like by using the vehicle-mounted display device, and the setting may be adjusted based on a configuration of the vehicle. However, the present disclosure is not limited to the control method described above. For example, some vehicles may offer lighting options in different colors and thus may allow the user to change the color of the vehicle lighting based on a user preference or a specific situation. The user may customize the setting based on the user's individual need and preference, and the vehicle lighting may be adjusted to be more intelligent and personalized when used together with the UWB communication equipment.

If the user (the user carries the UWB communication equipment capable of the UWB communication with the vehicle) is in any of the five regions described above, the corresponding vehicle lighting may be turned on to make the road clearly visible, and a lighting time may not be fixed until the user presses a lock button. If the user does not press the lock button, the corresponding vehicle lighting may be automatically turned off when the user gets into the vehicle and turns on the ignition. In addition, the lighting time of the vehicle lighting may be set to, for example, 30 seconds, 1 minute, or the like by using the vehicle-mounted display device.

Therefore, the UWB-based vehicle lighting control system according to an embodiment of the present disclosure may provide the user with better road lighting by accurately detecting the position of the user carrying the UWB communication equipment using the BDC and the UWB communication module installed in the vehicle and by automatically adjusting the light emission direction and height of the vehicle lighting based on the user position. Thus, the vehicle lighting is allowed to light a driver foot position and be moved based on the user position.

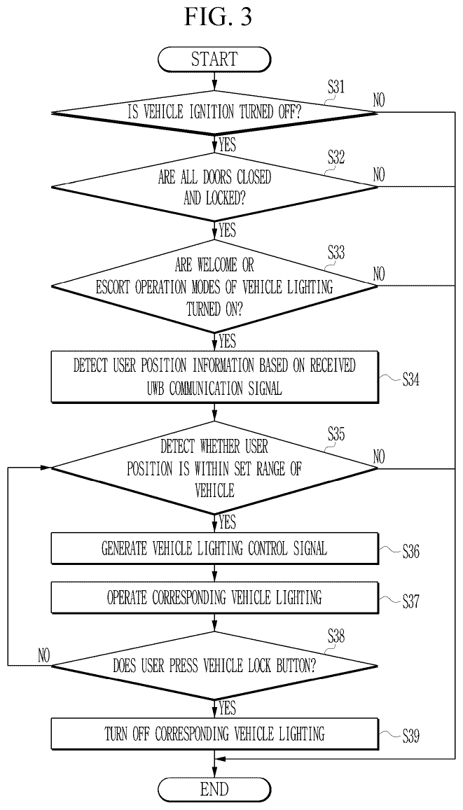

Referring to FIG. 3, the description below describes in detail a process flow of an ultra wide band (UWB)-based vehicle lighting control method according to an embodiment of the present disclosure.

Referring to FIG. 3, it may be determined whether the conditions of the welcome or escort operation mode of the vehicle lighting are satisfied by the main control device in steps S31 to S33. In detail, the main control device may determine whether the vehicle ignition is turned off in step S31. The main control device may determine whether all the doors are closed and locked in step S32. The main control device may determine whether the welcome or escort operation mode of the vehicle lighting are turned on in step S33.

The main control device may determine that the conditions of the welcome or escort operation mode of the vehicle lighting are satisfied if the vehicle ignition is turned off (i.e., “YES” in step S31), all the doors are closed and locked (i.e., “YES” in step S32), and the welcome or escort operation mode of the vehicle lighting are turned on (i.e., “YES” in step S33).

The main control device may determine that the conditions of the welcome or escort operation mode of the vehicle lighting are not satisfied. In other words, no subsequent processing related to the vehicle lighting control in the above-mentioned operation mode may be executed if at least one of the following occurs: the vehicle ignition is not turned off, at least one door is not closed or locked, or the welcome or escort operation mode of the vehicle lighting is not turned on.

If the conditions of the welcome or escort operation mode of the vehicle lighting are satisfied, in step S34, the user position information may be detected by the vehicle-mounted UWB communication device based on the received UWB communication signal of the UWB communication equipment of the user, the detected user position information may be converted into the vehicle-mounted communication signal, and the vehicle-mounted communication signal may be transmitted to the main control device.

In step S35, the main control device may determine whether the user position is within the set range of the vehicle based on the vehicle-mounted communication signal of the vehicle-mounted UWB communication device.

The vehicle lighting control signal may be generated by the main control device in step S36 if the user position is detected to be within the set range of the vehicle (i.e., “YES” in step S35). In detail, the vehicle lighting control signal may be generated to cause the headlight, the side light, and the tail light to respectively emit light to the entire first region evenly if the user position information indicates that the user is in the first region. The vehicle lighting control signal may be generated by the main control device to cause the headlight, the side light, and the tail light to respectively emit light toward the right side of the vehicle if the user position information indicates that the user is in the second region. The vehicle lighting control signal may be generated by the main control device to cause the headlight, the side light, and the tail light to respectively emit light toward the left side of the vehicle if the user position information indicates that the user is in the third region. The vehicle lighting control signal may be generated by the main control device to cause the headlight, the side light, and the tail light to respectively emit light toward the front side of the vehicle if the user position information indicates that the user is in the fourth region. The vehicle lighting control signal may be generated to cause the headlight, the side light, and the tail light to respectively emit light toward the rear side of the vehicle if the user position information indicates that the user is in the fifth region.

The vehicle lighting control signal may further include a signal causing the emission height of the vehicle lighting to be the first height below the UWB communication equipment carried by the user, and the first height may be set to the range of 20 cm to 160 cm. Therefore, the vehicle lighting may be ensured to emit light in the corresponding direction, and the vehicle lighting may be ensured simultaneously to emit light toward the user foot.

In step S37, the corresponding vehicle lighting may be operated by the vehicle lighting control device based on the vehicle lighting control signal of the main control device.

The main control device may determine whether the user presses the vehicle lock button in step S38 if the vehicle lighting is operated.

The vehicle lighting may then be turned off by the main control device in step S39 if the user is determined to press the vehicle lock button (i.e., “YES” in step S38).

The method may return to step S35 if it is determined that the user does not press the vehicle lock button (i.e., “NO” in step S38).

Hereinafter, the description describes an operation process of each of the UWB-based vehicle lighting control system and method according to an embodiment of the present disclosure in the welcome or escort mode. The UWB communication equipment carried by the user (or the driver) may be assumed to be the vehicle key, and the first height may be set to 120 cm.

When the driver approaches the vehicle and attempts to turn on the vehicle ignition (i.e., welcome mode), it may be determined by the main control device whether the conditions of the welcome or escort operation mode of the vehicle lighting are satisfied. If the conditions of the welcome or escort operation mode of the vehicle lighting are satisfied, the UWB communication with the vehicle key of the driver may be performed by the vehicle-mounted UWB communication device, and the UWB communication signal of the vehicle key may be received by the vehicle-mounted UWB communication device to detect position information of the vehicle key that includes a position of the vehicle key (i.e., driver position) and a height of the vehicle key. It may be detected by the main control device whether the driver position is within the set range of the vehicle based on the position information of the vehicle key.

It may be assumed that the driver approaches the vehicle from the front. In this case, if the driver position information indicates that the driver is in the fourth region, the vehicle lighting control signal may be generated by the main control device to cause the headlight, the side light, and the tail light to respectively emit light toward the front side of the vehicle, and to cause the emission height of the vehicle lighting to be 120 cm below the vehicle key (i.e., driver foot position). Thus, the vehicle lighting is prevented from reflecting into the driver eyes and affecting a driver view.

The driver may be provided with the better road lighting as the position to which the vehicle lighting emits light is changed based on the driver movement. The headlight, the side light, and the tail light may be caused to respectively emit light to the entire first region evenly (in other words, each light does not need to be deflected toward the front, rear, left, right, or the like of the vehicle) if the driver position information indicates that the driver is in the first region. The vehicle lighting control signal may be generated to cause the emission height of the vehicle lighting to be the first height below the vehicle key. The vehicle lighting may be turned off if the driver presses the vehicle lock button.

When the driver gets out of the vehicle, picks up an item from a trunk, and then attempts to leave the vehicle (i.e., escort mode), it may be determined by the main control device whether the conditions of the welcome or escort operation mode of the vehicle lighting are satisfied. If the conditions of the welcome or escort operation mode of the vehicle lighting are satisfied, the UWB communication with the vehicle key of the driver may be performed by the vehicle-mounted UWB communication device, and the UWB communication signal of the vehicle key may be received by the vehicle-mounted UWB communication device to thus detect the position information of the vehicle key that includes the position of the vehicle key (i.e., the driver position) and the height of the vehicle key. It may be detected by the main control device whether the driver position is within the set range of the vehicle based on the position information of the vehicle key.

If the driver position information indicates that the driver is in the first region (i.e., the driver gets out of the vehicle, goes to the trunk, and picks up the item in the trunk), the vehicle lighting control signal may be generated to cause the headlight, the side light, and the tail light to respectively emit light to the entire first region evenly (in other words, each light does not need to be deflected toward the front, rear, left, right, or the like of the vehicle), and the emission height of the vehicle lighting is set to be 120 cm below the vehicle key (i.e., driver foot position).

When the driver picks up the item and then attempts to leave the vehicle, the position to which the vehicle lighting emits light may be changed based on the driver movement, and thus the driver is provided with the better road lighting. If the driver position information indicates that the user is in the fifth region, the vehicle lighting control signal may be generated to cause the headlight, the side light, and the tail light to respectively emit light toward the rear side of the vehicle, and the emission height of the vehicle lighting is set to be 120 cm below the vehicle key. The vehicle lighting may be turned off when the driver presses the vehicle lock button.

Therefore, if the driver needs lighting while unloading the item from the vehicle or performing another activity near the vehicle, the UWB-based vehicle lighting control system and method according to the embodiments of the present disclosure may allow the vehicle lighting to be still operated and light the road for the driver.

The various embodiments of the present disclosure describe representative aspects of the present disclosure rather than enumerating all possible combinations thereof, and the contents described in the various embodiments may be applied alone or in combination of two or more.

The description of the embodiments above hereinabove is intended only to describe the technical approach of the present disclosure should not be considered complete and is not intended to limit the present disclosure to any accurate form described herein. It is apparent that those having ordinary skill in the art may make various modifications and changes to the embodiments disclosed above. The selection and description of the embodiments are intended to assist those having ordinary skill in the art to interpret the specific principles of the present disclosure and their practical applications and thus to utilize each embodiment of the present disclosure and its different alternatives and modifications. The scope of the present disclosure may be defined by the appended claims and their equivalents.

What is claimed is:

1. An ultra wide band (UWB)-based vehicle lighting control system comprising:
a UWB communication equipment configured to transmit and receive a UWB communication signal;
a vehicle-mounted UWB communication device including:
a UWB processing module configured to:
detect user position information based on the UWB communication signal received from the UWB communication equipment of the user; and
convert the detected user position information into a vehicle-mounted communication signal;
a plurality of vehicle-mounted UWB communication modules communicatively connected to the UWB processing module, the plurality of vehicle-mounted UWB communication modules configured to:
perform UWB communication with the UWB communication equipment carried by the user; and
transmit the UWB communication signal received from the UWB communication equipment of the user to the UWB processing module;
a main control device communicatively connected to the vehicle-mounted UWB communication device and configured to:
determine whether conditions of a welcome operation mode or an escort operation mode of vehicle lighting are satisfied; and
generate a vehicle lighting control signal based on the vehicle-mounted communication signal of the vehicle-mounted UWB communication device when the conditions of the welcome operation mode or the escort operation mode of the vehicle lighting are satisfied; and
a vehicle lighting control device communicatively connected to the main control device and electrically connected to the vehicle lighting, the vehicle lighting control device configured to:
operate the vehicle lighting based on the vehicle lighting control signal of the main control device; and
change a position to which the vehicle lighting emits light based on a user movement.

2. The system of claim 1,
wherein the conditions of the welcome operation mode or the escort operation mode of the vehicle lighting include whether a vehicle ignition is turned off, whether all doors are closed and locked, and whether the welcome operation mode or the escort operation mode of the vehicle lighting are turned on, and
wherein the main control device is further configured to:
determine that the conditions of the welcome operation mode or the escort operation mode of the vehicle lighting are satisfied when the vehicle ignition is turned off, all the doors are closed and locked, and the welcome operation mode or the escort operation mode of the vehicle lighting are turned on; and
determine that the conditions of the welcome operation mode or the escort operation mode of the vehicle lighting are not satisfied when the vehicle ignition is not turned off, at least one door is not closed or locked, or the welcome operation mode or the escort operation mode of the vehicle lighting is not turned on.

3. The system of claim 2,
wherein the welcome operation mode or the escort operation mode of the vehicle lighting are turned on when buttons related to the operation mode welcome or the escort operation mode of the vehicle lighting are pressed.

4. The system of claim 1,
wherein the main control device is further configured to:
detect whether a user position is within a set range of a vehicle based on the vehicle-mounted communication signal of the vehicle-mounted UWB communication device when the conditions of the welcome operation mode or the escort operation mode of the vehicle lighting are satisfied; and
generate the vehicle lighting control signal including a signal causing an emission height of the vehicle lighting to be a first height below the UWB communication equipment carried by the user when the user position is detected to be within the set range of the vehicle.

5. The system of claim 4,
wherein the set range of the vehicle indicates a range of distances between the user and a front side, a rear side, a left side, and a right side of the vehicle,
wherein the set range of the vehicle includes a first region, a second region, a third region, a fourth region, and a fifth region,
wherein the first region is set as a region where the distance between the user and the front side, the rear side, the left side, and the right side of the vehicle is less than or equal to a first distance,
wherein the second region is set as a region where the distance between the user and the right side of the vehicle is greater than the first distance and less than or equal to a second distance,
wherein the third region is set as a region where the distance between the user and the left side of the vehicle is greater than the first distance and less than or equal to the second distance,
wherein the fourth region is set as a region where the distance between the user and the front side of the vehicle is greater than the first distance and less than or equal to the second distance, and
wherein the fifth region is set as a region where the distance between the user and the rear side of the vehicle is greater than the first distance and less than or equal to the second distance.

6. The system of claim 5,
wherein the vehicle lighting control device includes a headlight controller, a side light controller, and a tail light controller, and
wherein the headlight controller, the side light controller, and the tail light controller are configured to cause a headlight, a side light, and a tail light to respectively emit light to the first region when the user position information indicates that the user is in the first region,
wherein the headlight controller, the side light controller, and the tail light controller cause the headlight, the side light, and the tail light respectively to emit light toward the right side of the vehicle when the user position information indicates that the user is in the second region,
wherein the headlight controller, the side light controller, and the tail light controller are configured to cause the headlight, the side light, and the tail light to respectively emit light toward the left side of the vehicle when the user position information indicates that the user is in the third region,
wherein the headlight controller, the side light controller, and the tail light controller are configured to cause the headlight, the side light, and the tail light to respectively emit light toward the front side of the vehicle when the user position information indicates that the user is in the fourth region, and
wherein the headlight controller, the side light controller, and the tail light controller are configured to cause the headlight, the side light, and the tail light to respectively emit light toward the rear side of the vehicle when the user position information indicates that the user is in the fifth region.

7. The system of claim 4, further comprising:
a display device communicatively connected to the main control device,
wherein the user is further configured to set the vehicle lighting to emit light to the first height below the UWB communication equipment carried by the user using the display device, and
wherein the first height is set to a range of 20 cm to 160 cm.

8. The system of claim 1,
wherein the UWB communication equipment includes a vehicle key and/or a mobile device, and
wherein the plurality of vehicle-mounted UWB communication modules includes five vehicle-mounted UWB communication modules being respectively installed at a left front corner, a right front corner, a left rear corner, a right rear corner, and a front roof of the vehicle.

9. The system of claim 1,
wherein the UWB communication equipment of the user includes a vehicle lock button, and
wherein the vehicle lighting is turned off when the user presses the vehicle lock button while the vehicle lighting is in operation.

10. The system of claim 1,
wherein a communicative connection includes a connection using a wired communication method, and
wherein the wired communication method includes a controller area network (CAN), a universal serial bus (USB), a high definition multimedia interface (HDMI), or a digital visual interface (DVI).

11. An ultra wide band (UWB)-based vehicle lighting control method comprising:
transmitting and receiving, by a UWB communication equipment carried by a user, a UWB communication signal;
detecting, by a vehicle-mounted UWB communication device, user position information based on the UWB communication signal received from the UWB communication equipment of the user;
operating, by a vehicle lighting control device, vehicle lighting based on a vehicle lighting control signal received from a main control device; and
changing, by the vehicle lighting control device, a position to which the vehicle lighting emits light based on a user movement.

12. The method of claim 11, further comprising:
determining, by a main control device, whether conditions of a welcome operation mode or an escort operation mode of vehicle lighting are satisfied; and
generating, by the main control device, a vehicle lighting control signal based on a vehicle-mounted communication signal received from the vehicle-mounted UWB communication device when the conditions of the welcome operation mode or the escort operation mode of the vehicle lighting are satisfied.

13. The method of claim 12,
wherein the conditions of the welcome operation mode or the escort operation mode of the vehicle lighting include whether a vehicle ignition is turned off, whether all doors are closed and locked, and whether the welcome operation mode or the escort operation mode of the vehicle lighting are turned on, and
wherein the method further comprises determining, by the main control device, that the conditions of the welcome operation mode or the escort operation mode of the vehicle lighting are satisfied when the vehicle ignition is turned off, all the doors are closed and locked, and the welcome operation mode or the escort operation mode of the vehicle lighting are turned on, and
wherein the method further comprises determining, by the main control device, that the conditions of the welcome operation mode or the escort operation mode of the vehicle lighting are not satisfied when the vehicle ignition is not turned off, at least one door is not closed or locked, or the welcome operation mode or the escort operation mode of the vehicle lighting is not turned on.

14. The method of claim 13, further comprising:
turning on the welcome operation mode or the escort operation mode of the vehicle lighting when buttons related to the welcome operation mode or the escort operation mode of the vehicle lighting are pressed.

15. The method of claim 12, further comprising:
detecting, by the main control device, whether a user position is within a set range of a vehicle based on the vehicle-mounted communication signal of the vehicle-mounted UWB communication device when the conditions of the welcome operation mode or the escort operation mode of the vehicle lighting are satisfied; and
generating, by the main control device, the vehicle lighting control signal including a signal causing an emission height of the vehicle lighting to be a first height below the UWB communication equipment carried by the user when the user position is detected to be within the set range of the vehicle.

16. The method of claim 15,
wherein the set range of the vehicle indicates a range of distances between the user and a front side, a rear side, a left side, and a right side of the vehicle,
wherein the set range of the vehicle includes a first region, a second region, a third region, a fourth region, and a fifth region,
wherein the first region is set as a region where the distance between the user and the front side, the rear side, the left side, and the right side of the vehicle is less than or equal to a first distance,
wherein the second region is set as a region where the distance between the user and the right side of the vehicle is greater than the first distance and less than or equal to a second distance,
wherein the third region is set as a region where the distance between the user and the left side of the vehicle is greater than the first distance and less than or equal to the second distance,
wherein the fourth region is set as a region where the distance between the user and the front side of the vehicle is greater than the first distance and less than or equal to the second distance, and
wherein the fifth region is set as a region where the distance between the user and the rear side of the vehicle is greater than the first distance and less than or equal to the second distance.

17. The method of claim 16, further comprising:
generating, by the main control device, the vehicle lighting control signal causing a headlight, a side light, and a tail light to respectively emit light to the first region when the user position information indicates that the user is in the first region;
generating, by the main control device, the vehicle lighting control signal causing the headlight, the side light, and the tail light respectively to emit light toward the right side of the vehicle when the user position information indicates that the user is in the second region;
generating, by the main control device, the vehicle lighting control signal causing the headlight, the side light, and the tail light to respectively emit light toward the left side of the vehicle when the user position information indicates that the user is in the third region;
generating, by the main control device, the vehicle lighting control signal causing the headlight, the side light, and the tail light to respectively emit light toward the front side of the vehicle when the user position information indicates that the user is in the fourth region; and
generating, by the main control device, the vehicle lighting control signal causing the headlight, the side light, and the tail light to respectively emit light toward the rear side of the vehicle when the user position information indicates that the user is in the fifth region.

18. The method of claim 15, further comprising:
setting, by the user, the vehicle lighting to emit light to the first height below the UWB communication equipment carried by the user using a display device; and
setting the first height to a range of 20 cm to 160 cm.

19. The method of claim 12, further comprising:
turning off the vehicle lighting when the user presses a vehicle lock button while the vehicle lighting is in operation.

20. The method of claim 12,
wherein the UWB communication equipment includes a vehicle key and/or a mobile device,
wherein the vehicle-mounted UWB communication device includes a plurality of vehicle-mounted UWB communication modules, and
wherein the plurality of vehicle-mounted UWB communication modules includes five vehicle-mounted UWB communication modules being respectively installed at a left front corner, a right front corner, a left rear corner, a right rear corner, and a front roof of the vehicle.
